(19) United States
(12) Patent Application Publication
(10) Pub. No.: US 2004/0202823 A1
(43) Pub. Date: Oct. 14, 2004

(54) Ceramic laminate and method for manufacturing the same

(76) Inventors: Hideki Yoshikawa, Hyogo (JP); Takashi Umemoto, Osaka (JP); Keiichi Kuramoto, Osaka (JP); Hitoshi Hirano, Hyogo (JP)

Correspondence Address: FISH & RICHARDSON P.C., 45 ROCKEFELLER PLAZA, SUITE 2800, NEW YORK, NY, 10111, US

(21) Appl. No.: 10/352,514

(22) Filed: Jan. 28, 2003

(30) Foreign Application Priority Data
Jan. 28, 2002 (JP) P.2002-017880

(51) Int. Cl. B32B 1/00

(52) U.S. Cl. 428/174; 264/621; 264/681

(57) ABSTRACT

Between dielectric ceramic sheets 11A-11C and magnetic ceramic sheets 13A-13C, metallic alkoxide solution films are formed so as not to interfere with wiring patterns 12A-12C and 14A-14C. Thereafter, the dielectric ceramic sheets 11A-11C and the magnetic ceramic sheets 13A-13C are stacked and heat-treated at the temperature of about 200-400° C. This heat treatment leads to a sol-gel reaction of the metallic alkoxide solution, thereby providing intermediate layers 15. Through the intermediate layers 15, the adjacent ceramic sheets are coupled with each other. Since the ceramic sheets are coupled with each other using the sol-gel reaction which proceeds at a low temperature of about 200-400° C., the ceramic laminate is prevented from being deformed due to a difference in the thermal shrinkage coefficient between the ceramic sheets, thereby providing a ceramic laminate with no warpage and peeling.

### BACKGROUND OF THE INVENTION

This invention relates to a ceramic laminate and a method for manufacturing the same, and more particularly to a ceramic laminate which is used as a laminate ceramic substrate board for a high frequency circuit, and a method for manufacturing the same.

Now, there is a continuing demand for miniaturization and sophistication of portable communication equipment such as a portable telephone. This leads to an increasing strict demand for miniaturization and sophistication for a high frequency circuit board used for the portable communication equipment.

In order to satisfy such a demand, there is a proposal of using, as a laminate ceramic board for a high frequency circuit, in place of a circuit board in which a capacitor and an inductor are surface-mounted, a ceramic laminate in which the capacitor and inductor are incorporated in the board itself by stacking a dielectric ceramic board with a wiring pattern of the capacitor formed thereon and a magnetic ceramic board with that of the inductor formed thereon. Using such a ceramic laminate as a high frequency circuit board can realize miniaturizing and low-profiling so that its commercialization is being understudy.

FIG. 7A is a perspective view showing an example of a ceramic laminate. As seen from FIG. 7B, a ceramic laminate 70 is manufactured in such a way that a dielectric ceramic laminate 71 composed of a plurality of (three in an illustrated example) dielectric ceramic sheets (substrates) 72A, 72B, and 72C on which prescribed wiring patterns 71A, 71B and 71C constituting capacitors, respectively, and a magnetic ceramic laminate 73 composed of a plurality of (three in the illustrated example) magnetic ceramic sheets (substrates) 74A, 74B and 74C on which prescribed wiring patterns 73A, 73B and 73C constituting inductors, respectively are stacked on each other, and thereafter collectively fired at a high temperature of about 800-1300° C. Ceramic sheets made of e.g. glass ceramic may be used as the dielectric ceramic sheets 71A, 71B and 71C. Ceramic sheets made of e.g. NiClZn system ferrite may be used as the magnetic ceramic sheets 73A, 73B and 73C.

Because the ceramic laminate 70 incorporates the inductor and capacitor in itself, it can reduce the number of inductors and capacitors as surface-mounted components. Therefore, using this ceramic laminate as a circuit board for a high frequency circuit can miniaturize a high frequency circuit module.

The ceramic laminate manufactured by the conventional technique presents a problem that as shown in FIG. 8C. A ceramic laminate 80 involves a warp generated owing to a difference in the shrinkage coefficient between the dielectric ceramic laminate and the magnetic ceramic laminate in the process of firing the stacked ceramic sheets of different materials to form a single ceramic sintered body. The degree of warp depends on the kind and thickness of the ceramic sheet, mixing ratio of a material powder and binder, granule diameter and shape of the material powder, firing condition, etc.

Where there is no warp in the ceramic laminate 80, as seen from FIG. 8A, there is no disconnection in the electrical contact between the wiring patterns 83 and 84 formed on adjacent ceramic sheets 81 and 82, respectively. On the other hand, where there is a warp in the ceramic laminate 80, as seen from FIG. 8B, the wiring patterns 83 and 84 formed on adjacent ceramic sheets 81 and 82 may be separated from each other owing to peeling of the ceramic sheets 81 and 82 from each other. In such a case, the wiring resistance is increased so that the characteristic of a high frequency circuit module is greatly deteriorated. Further, if the warp increases, as seen from FIG. 8C, the ceramic laminate 80 involves breakage 85, thereby greatly reducing the production yield.

### SUMMARY OF THE INVENTION

This invention has been accomplished in view of the circumstance described above, and intends to provide a ceramic laminate with no warp or peeling.

Particularly, this invention intends to provide a ceramic laminate with no warp which is formed by stacking ceramic sheets with different thermal shrinkage coefficients, e.g. a dielectric ceramic sheet and a magnetic ceramic sheet on each other, and a method for manufacturing the same.

In order to attain the above object, the invention is characterized in that an intermediate layer made of metallic oxide is located at a boundary between at least a pair of ceramic sheets that are adjacent to each other.

In accordance with such a configuration, since the ceramic sheets are fixed to each other through the intermediate layer of metallic oxide, a smaller difference in the thermal shrinkage coefficient results than they are fixed by powder firing technique and the intermediate layer also serves as an insulating layer. For this reason, a low-profile ceramic laminate with high capability of fixing can be obtained. Particularly, the metallic oxide is coupled with the elements contained within the ceramic sheets through oxygen atoms. Therefore, the ceramic sheets are in more intimate contact with each other than they are fixed to each other via resin so that the ceramic laminate can have high resistance to humidity and high capability of contact.

Further, according to the invention, the intermediate layer is located in a concave area encircled by each of the wiring patterns formed on at least one of surfaces of the ceramic sheet.

In accordance with such a configuration, the ceramic sheets are electrically connected at the area where the wiring patterns of the adjacent ceramic sheets are in contact with each other and mechanically connected (or fixed) to each other through the intermediate layer of the metallic oxide in the concave area encircling the wiring patterns. For this reason, stress is smaller than the case where a bonding layer is wholly formed. The electric connection with high reliability can be realized in the area where the electric connection is to be made and the mechanical connection and insulation for the mutual wiring patterns can be assured in the area where the mechanical connection is to be made. Thus, the low-profile and reliable ceramic laminate can be obtained.

Preferably, at least the pair of adjacent ceramic sheets have different thermal shrinkage coefficients.

Preferably, the intermediate layer is made of a metallic oxide created by the sol-gel reaction of a metallic alkoxide solution.

In this case, the intermediate layer can be formed at a low temperature, and formed by heating with a liquid solution being in contact between the ceramic sheets. The metallic oxide is not present in the convex area where the wiring pattern is present, but selectively present in the concave area around the convex area, i.e. area to be insulted, thereby making the mechanical connection. Thus, a low profile and reliable connection can be realized.

Preferably, the intermediate layer has a thickness equal to or shorter than that of each of the wiring patterns.

In accordance with such a configuration, the metallic oxide is not present in the convex area where the wiring pattern is present, but selectively present in the concave area around the convex area, i.e. area to be insulted, thereby making the mechanical connection. Thus, a low profile and reliable connection can be realized.

Preferably, the metallic oxide of the intermediate layer is SiO₂.

In accordance with such a configuration, since the metallic oxide which constitutes the intermediate layer is a good insulator, improved electric characteristic can be realized.

Preferably, the invention is characterized in that the intermediate layer has a density of 1.0-1.2 g/cm³.

Preferably, a gap between the adjacent ceramic sheets is filled with the intermediate layer.

In accordance with such a configuration, the area except the area where electric connection is to be made is completely filled with the metallic oxide, thereby providing high capability of electrical connection.

Preferably, the intermediate layer is formed at the position where it does not interfere with the wiring patterns.

Preferably, the adjacent ceramic sheets have wiring patterns on their opposite surfaces, respectively, and at least one contact is formed by contact between both wiring patterns.

The method according to this invention comprises: a superposing step of superposing at least two ceramic sheets having different thermal shrinkage coefficients through a metallic alkoxide solution; and a heat treating step of heat-treating the ceramic sheets at a temperature in which the metallic alkoxide solution induces a sol-gel reaction so that the ceramic sheets are coupled with each other through an intermediate layer which is made of metallic oxide created by the sol-gel reaction.

In accordance with such a configuration, since the intermediate layer, which is made of metallic oxide created by the sol-gel reaction of a metallic alkoxide solution, is located between at least a pair of adjacent ceramic sheets, deformation of the ceramic sheets owing to thermal process can be reduced. Therefore, the ceramic laminate can be prevented from being deformed owing to the difference in the thermal shrinkage coefficients between both ceramic sheets. Thus, the warp or peeling can be suppressed between the magnetic layer and the dielectric layer having different thermal shrinkage characteristics or between the ceramic sheets having different thicknesses.

Further, since the metallic oxide such as SiO₂ which constitutes an intermediate layer is coupled with the elements contained in both ceramic sheets through oxygen elements, the reliability such as resistance to humidity of the ceramic laminate can be improved.

Preferably, the superposing step is to superpose the ceramic sheet which have been fired through the metallic alkoxide solution.

Since the ceramic sheets which have once been fired are superposed, the warp of the ceramic laminate owing to the difference in the shrinkage coefficient in the coupling step.

Preferably, the heat treating step is to heat under pressure.

The heating under pressure extrudes the metallic alkoxide solution in the area where the wiring patterns are in contact with each other so that the metallic alkoxide moves to the surrounding concave area. This assures the contact between the wiring patterns and connection with high reliability.

Preferably, the metallic oxide of the intermediate layer is SiO₂.

Preferably, the heat treating step is to heat at a temperature of 400° C. or lower.

Further, by forming the intermediate layer at the position where it does not interfere with the wiring patterns, electric connection between the wiring patterns of the adjacent ceramic sheets can be assured.

### BRIEF DESCRIPTION OF THE DRAWINGS

FIG. 1A is a perspective view of a structure of a ceramic laminate according to a first embodiment this invention;

FIG. 1B is an exploded perspective view;

FIGS. 2A to 2D are manufacturing flowcharts showing an example of the method of manufacturing the ceramic laminate according to the second embodiment of this invention;

FIG. 3 is a perspective view of a structure of a ceramic laminate according to a third embodiment of this invention;

FIGS. 4A to 4C are manufacturing flowcharts showing a method of manufacturing the ceramic laminate shown in FIG. 3;

FIG. 5A is aside view of a structure of the ceramic laminate according to this invention;

FIG. 5B is a view for explaining a combined structure of adjacent ceramic sheets and an intermediate layer therebetween;

FIG. 6A is an appearance view of the ceramic laminate manufactured by a conventional manufacturing method;

FIG. 6B is an appearance view of the ceramic laminate manufactured by the manufacturing method according to this invention;

FIG. 7A is a perspective view of an exemplary structure of a convention ceramic laminate;

FIG. 7B is an exploded perspective view;

FIG. 8A is a sectional view of a combined state of wiring patterns when a ceramic laminate does not have warp;

FIG. 8B is a sectional view of a combined state of wiring patterns when a ceramic laminate has warp; and

FIG. 8C is a side view showing the state where warp occurred in the ceramic laminate.

### DETAILED DESCRIPTION OF THE DRAWINGS

An explanation will be given of various embodiments of this invention hereinbelow.

Embodiment 1

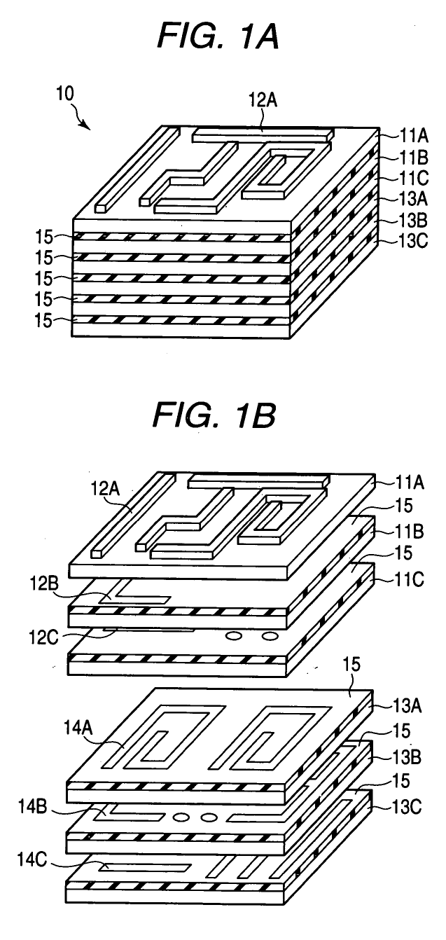

FIG. 1A is a perspective view of a first embodiment of a ceramic laminate and FIG. 1B is an exploded perspective view.

As seen from FIG. 1A, a ceramic laminate 10 includes a plurality of (three in this embodiment) dielectric ceramic sheets 11A-11C and a plurality of (three in this embodiment) magnetic ceramic sheets 13A-13C which are fixedly stacked on each other through intermediate layers 15 which are made of silicon oxide, respectively. As seen from FIG. 1B, on the dielectric ceramic sheets 11A-11C, predetermined wiring patterns 12A-12C which mainly constitute capacitors are formed, respectively, whereas on the dielectric ceramic sheets 13A-13C, predetermined wiring patterns 14A-14C which mainly constitute inductors are formed, respectively. It should be noted that all the dielectric ceramic sheets and the magnetic ceramic sheets 13A-13C are created boards. The wiring patterns 12A-12C and 14A-14C formed by the known screen printing technique.

As seen from FIG. 1B, the ceramic laminate 10 is manufactured in such a manner that after the wiring patterns 12A-12C and 14A-14C and metallic alkoxide solution films 16A, 16B, 17A-17C serving as starting materials of the intermediate layers 15 have been formed between all the adjacent ceramic sheets 11A-11C and 13A-13C, the dielectric ceramic sheets 11A-11C and the magnetic ceramic sheets 13A-13C are stacked and heat-treated at the temperature of about 200-400° C. The heat treatment at the temperature of 200-400° C. leads to a sol-gel reaction of the metallic alkoxide solution between the ceramic sheets, thereby providing the intermediate layers 15. Through the intermediate layers 15, the adjacent ceramic sheets are coupled with each other.

The sol-gel reaction when e.g. tetraethoxysilane (Si (OC₂H₆)₄) is used as the metallic alkoxide solution is represented by the following equation of hydrolysis.

Si(OC₂H₆)₄+2H₂O→SiO₂+4C₂H₅OH

As a result of the sol-gel reaction, stable SiO₂ coupling layers (intermediate layers) 15 are formed.

The sol-gel reaction proceeds at a low temperature of about 200-400° C. which is much lower than the firing temperature (800° C. or higher) necessary to couple the stacked ceramic sheets with each other by firing.

Therefore, the warp generated when the stacked green sheets are fired is not produced in the ceramic laminate. This obviates a problem that the wiring patterns formed on the adjacent ceramic sheets are separated from each other and breakage is generated in the ceramic sheet.

Further, the intermediate layers 15 which are the results of the sol-gel reaction are formed at positions where they do not interfere with the wiring patterns formed on the dielectric ceramic sheets 11A-11C and magnetic ceramic sheets 13A-13C, respectively. For this reason, electric connection between the wiring patters of the adjacent ceramic sheets is assured.

The intermediate layers 15 which constitute metal oxide are also coupled with the elements contained within the ceramic sheets through oxygen atoms. Therefore, the ceramic sheets are in more intimate contact with each other than they are fixed to each other via resin, thereby providing high resistance to humidity of the ceramic laminate.

The starting material for forming the intermediate layer 15 may be any material as long as it is metal alkoxide containing the metal element having at least two hydrolysable groups. For example, the metal alkoxide containing silicon includes, in addition to the above tetraethoxy silane, tetramethoxysilane, tetranpropoxysilane, tetraisopropoxysilane, tetranbutoxysilane, tetraisobutoxysilane, phenyltriethoxysilane, etc. The silicon atom (Si) of the metallic alkoxide may be replaced by titanium (Ti), zirconium (Zr), aluminium (Al), tin (Sn) or zinc (Zn). Two or more kinds of metallic alkoxide may be combined.

In the example shown in FIG. 1, the intermediate layers 15 are located between adjacent ones of all the ceramic sheets which constitute the ceramic laminate 10. However, the intermediate layer 15 may be located between at least a pair of adjacent ceramic sheets, for example, only between the dielectric ceramic sheet 11C and magnetic ceramic sheet 13A which have different thermal shrinkage coefficients.

In the example shown in FIG. 1, six ceramic sheets consisting of three dielectric ceramic sheets and three magnetic ceramic sheets are stacked to constitute the ceramic laminate. However, actually, any number of layers may be stacked.

Further, the wiring pattern illustrated in FIG. 1 is conceptual, and the wiring pattern actually adopted is not illustrated accurately.

Embodiment 2

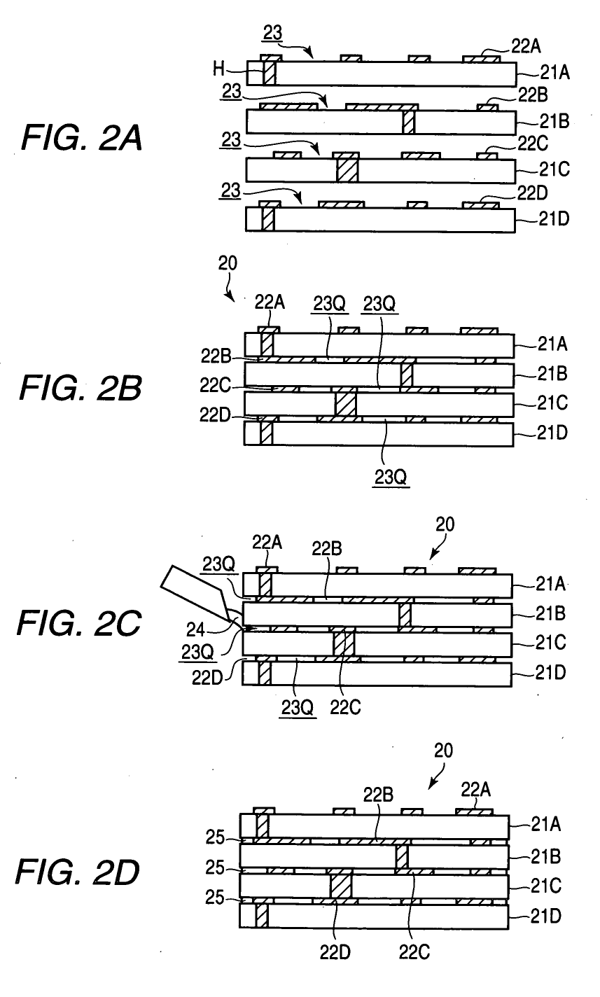

Now referring to FIGS. 2A to 2D, an explanation will be given of a method for manufacturing the ceramic laminate according to this invention.

First, as seen from FIG. 2A, predetermined wiring patterns 22A-22D are formed on dielectric ceramic sheets 21A, 21B and magnetic ceramic sheets 21C, 21D each of which has a thickness of 40-150 μm, respectively, by e.g. screen printing. Between the adjacent ones of the respective wiring patterns 22A-22D of the ceramic sheets 21A-21D, the surface of each of the ceramic sheets 21A-21D is partially exposed, and the exposed surface portion constitutes a concave portion 23 for each of the wiring patterns 22A-22D. The dielectric ceramic sheets and magnetic ceramic sheets have a thickness of about 40-150 μm, and the wiring patterns have a thickness of about 2-5 μm. Symbol H denotes a through hole.

As seen from FIG. 2B, the dielectric ceramic sheets 21A, 21B and magnetic ceramic sheets 21C, 21D are stacked to form a ceramic laminate 20. Between the adjacent ones of the ceramic sheets 21A-21D which constitute the ceramic laminate 20, there are areas with wiring patterns 22A-22D and gaps 23Q with no wiring patterns 22A-22D.

As seen from FIG. 2C, a metallic alkoxide solution 24 is poured in each of the gaps 23Q between the adjacent ceramic sheets of the ceramic laminate 20. Only the gaps 23Q with no wiring patterns are filled with the metallic alkoxide solution 24.

The ceramic laminate 20 is heat-treated for a prescribed time at a temperature of 200-400° C. By this heat treatment, the metallic alkoxide solution with which the gaps 23Q of the ceramic laminate are filled is hardened through the sol-gel reaction. Thus, as seen from FIG. 2D, intermediate layers 25 of metal oxide are formed. The intermediate layer 25 couples the adjacent ceramic sheets of the ceramic laminate 20 with each other. The intermediate layers 25 are formed in only the gaps 23Q with no wiring patterns 22A-22D.

Therefore, electric connection between the wiring patterns on the adjacent ceramic sheets is assured.

The example as shown in FIG. 2 is the ceramic laminate in which a total of four layers consisting of two dielectric ceramic sheets and magnetic ceramic sheets are stacked. However, the number of layers should not be limited to four.

Embodiment 3

An explanation will be given of the third embodiment of this invention.

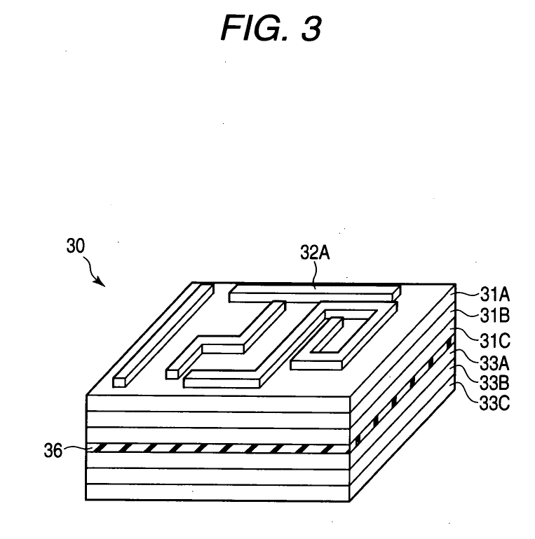

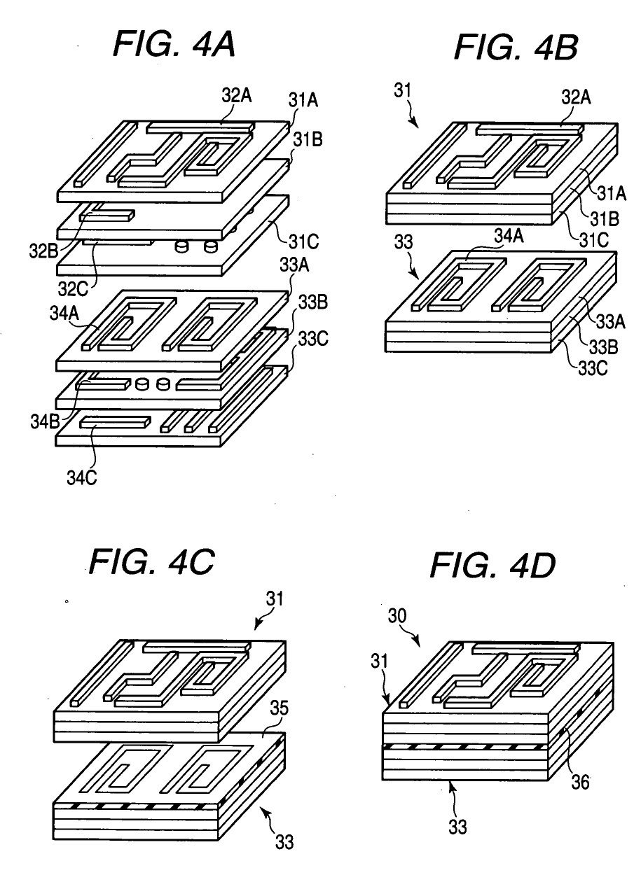

FIG. 3 is a perspective view of the third embodiment of the ceramic laminate according to this invention. A ceramic laminate 30 is manufactured through the steps of FIGS. 4A to 4D.

In the first and second embodiments described above, the magnetic and dielectric ceramic sheets are individually fired and thereafter the wiring patterns are printed thereon. Further, the ceramic sheets are stacked through the metallic alkoxide solution and coupled with each other through the sol-gel technique. On the other hand, in this embodiment, a dielectric ceramic laminate and a magnetic ceramic laminate are coupled with each Other under pressure by the sol-gel technique to form a composite ceramic laminate. In this case, the dielectric ceramic laminate is prepared by stacking a plurality of dielectric green sheets with wiring patterns thereon, respectively and firing them. The magnetic ceramic laminate is prepared by stacking a plurality of magnetic green sheets with wiring patterns thereon, respectively and firing them.

Specifically, first, as seen from FIG. 4A, predetermined wiring patterns 32A-32C and 34A-34C are formed on dielectric ceramic sheets 31A-31C and magnetic ceramic sheets 33A-33C, respectively by e.g. the screen printing technique.

The dielectric ceramic sheets 31A-31C may be ceramic sheets of e.g. barium titanate, and the magnetic ceramic sheets 33A-33C may be ceramic sheets of e.g. NiZn ferrite.

The wiring patterns 32A-32C formed on the dielectric ceramic sheets 31A-31C constitute a circuit mainly consisting of C (capacitance) components, and the wiring patterns 34A-34C formed on the magnetic ceramic sheets 33A-33C constitutes a circuit mainly consisting of L (inductance) components.

Next, as seen from FIG. 4B, the dielectric ceramic sheets 31A-31C are stacked to form a dielectric ceramic laminate 31, and the magnetic ceramic sheets 33A-33C are stacked to form a magnetic ceramic laminate 22. The ceramic laminates 31 and 33 are fired at a high temperature of 800-1600° C.

Thereafter, as seen from FIG. 4C, a metallic alkoxide solution film 35 is formed on a junction plane (formed on the upper surface of the laminate 33 in the illustrated example) between the dielectric ceramic laminate 31 and the magnetic ceramic laminate 33 so that it does not interfere with the wiring patterns. As seen from FIG. 4D, the dielectric ceramic laminate 31 and the magnetic ceramic laminate 33 are stacked, pressurized and heat-treated for a prescribed time at a temperature of about 200-400° C.

By this heat treatment, the metallic alkoxide solution which intervenes between the dielectric ceramic laminate 31 and the magnetic ceramic laminate 33 is hardened through the sol-gel reaction to form an intermediate layer 36 of the metallic oxide. The intermediate layer 36 couples the dielectric ceramic laminate 31 and the magnetic ceramic laminate 33 of the ceramic laminate 30 with each other. Since the intermediate layer is formed at the position where the wiring patterns 32C and 34A are not located, the electric connection between the wiring patterns 32C and 34A is assured between the dielectric ceramic laminate 31 and magnetic ceramic laminate 33.

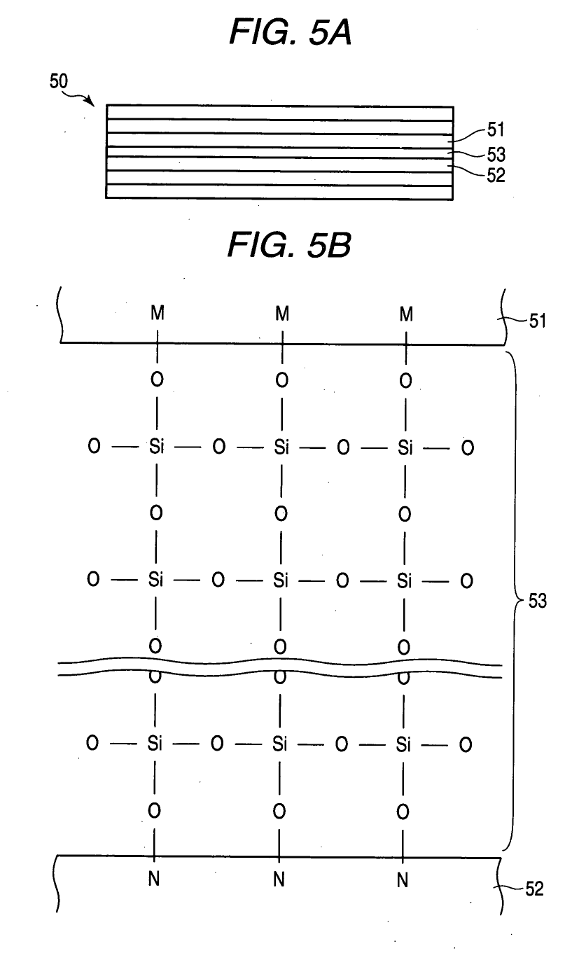

Now referring to FIG. 5, a detailed explanation will be given of the operation and effect of the above embodiment.

In the embodiment described above, since the adjacent ceramic sheets of the ceramic laminate 31 are coupled with each other using the sol-gel reaction which proceeds at a low temperature of about 200-400° C., the ceramic laminate is prevented from being deformed due to a difference in the thermal shrinkage coefficient between the ceramic sheets thereby providing a ceramic laminate 50 with no warp and peeling as shown in FIG. 5A. FIG. 5A shows a ceramic laminate 50 in which a dielectric ceramic sheet 51 and a magnetic ceramic sheet 52 which have equal thicknesses and different thermal shrinkage coefficients are coupled with each other through the intermediate layer 53 formed by the sol-gel reaction of the metallic alkoxide solution. However, also in the configuration in which the ceramic sheets having equal thermal shrinkage coefficients are stacked and integrated, the ceramic laminate with no warp and peeling can be obtained by the intervention of the intermediate layer 53.

Since the reaction of coupling the dielectric ceramic sheet 51 and the magnetic ceramic sheet 52 with each other is carried outer a low temperature as described above and the intermediate layer 53 which is made of the metallic oxide layer intervenes between the dielectric ceramic sheet 51 and magnetic ceramic sheet 52, the diffusion of the component which forms the dielectric layer into the magnetic layer and the diffusion of the component which forms the magnetic layer into the dielectric layer can be reduced, thereby improving the characteristic of the ceramic laminate 31.

The intermediate layer 53 which is formed as a result that the metallic alkoxide solution has been hardened has a structure of metallic oxide as shown in FIG. 5B. As seen, the intermediate layer 53 is also coupled with the elements contained within the dielectric ceramic sheet 51 and magnetic ceramic sheet 52 through oxygen atoms. For this reason, the intermediate layer 53 has higher reliability in humidity resistance than the other material hardened at a low temperature, e.g. resin.

Since the ceramic laminate having the advantages described above can have a wide range of capacitance C of a capacitor and inductance L of an inductor, by reducing the number of inductors and capacitors which are surface-mounted components, the high frequency circuit module can be miniaturized. Particularly, by employing a ferroelectric material such as barium titanate as a martial for the dielectric ceramic sheet 51 and employing a high frequency magnetic material such as NiCuZn ferrite and Ba system hexagonal ferrite for the magnetic ceramic sheet 52, a wider range of capacitance C values and inductance L values than in the ceramic laminate using alumina or glass ceramic can be obtained, thereby further miniaturizing the high frequency circuit module.

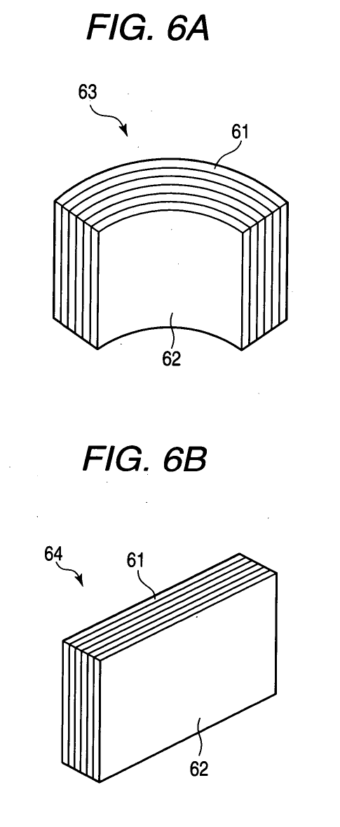

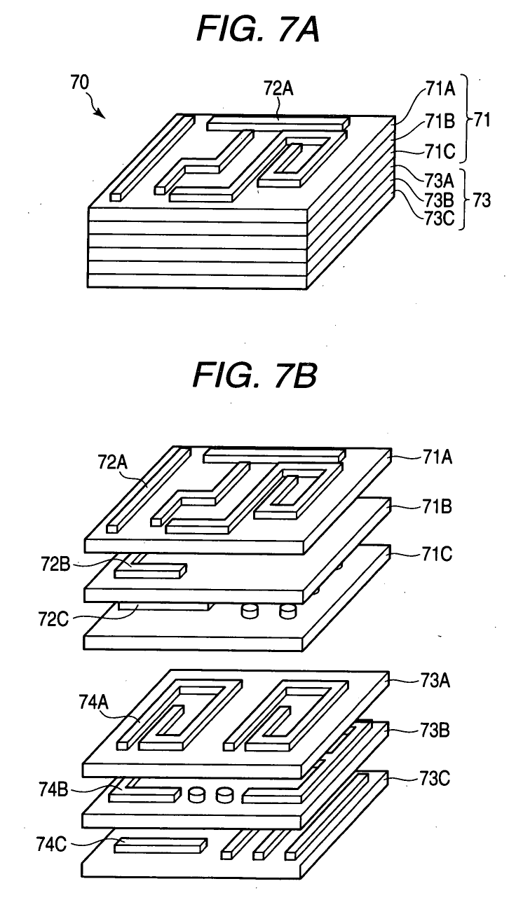

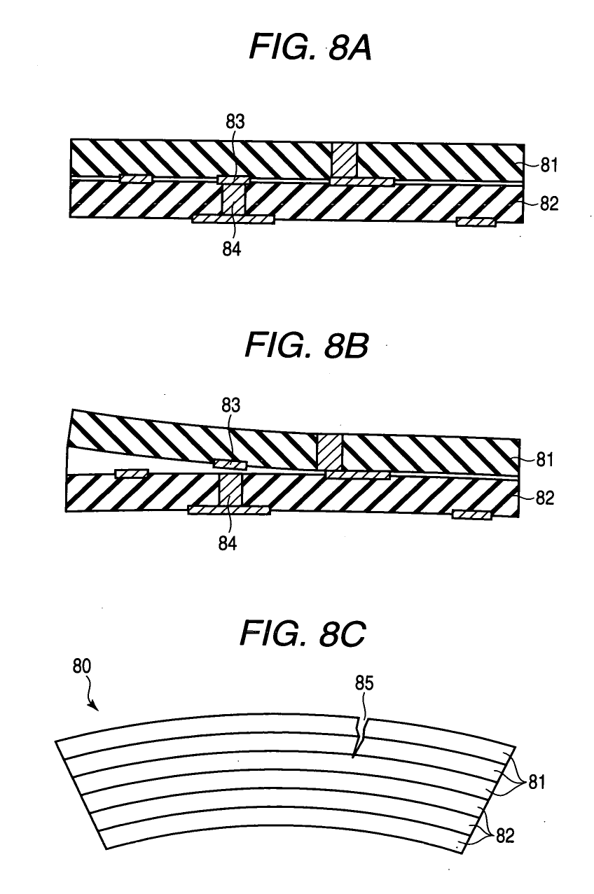

FIGS. 6A and 6B are appearance views of the ceramic laminates which have been actually manufactured. The ceramic laminates 63 and 64 each is a structure in which magnetic ceramic sheets 61 of Ba-system hexagonal ferrite and dielectric ceramic material sheets 62 each of which is a general LTC sheet are stacked and integrated.

FIG. 6A shows the structure in which the magnetic ceramic sheets 61 and dielectric ceramic sheets 62 have been combined by a conventional manufacturing method, i.e. by the heat treatment at a firing temperature (900° C.) of the ceramic material. Owing to a difference in the thermal characteristic (expansion coefficient, shrinkage coefficient, etc.) between both sheets, the ceramic laminate 63 produces warpage and peeling during the heat treatment so that the ceramic laminate with different kinds of ceramic sheets combined satisfactorily could not be realized.

On the other hand, FIG. 6B shows a resultant structure when the magnetic ceramic sheets 61 and the dielectric ceramic sheets 62 are superposed on each other with a metallic alkoxide solution (tetraethoxysilane and polyvinylpyrolidone) applied on the coupling plane therebetween and heated on a hot plate at a temperature of 200° C. to harden the metal alkoxide solution. Because of not using the high temperature process, a ceramic laminate 64 with no warpage and peeling could be realized.

In the embodiments described above, the composite ceramic laminates in each of which the ceramic sheets of different kinds of material, i.e. dielectric and magnetic material were explained. However, this invention can be also applied to the ceramic laminate in which the ceramic sheets of the same material. Namely, this invention can also be applied to the dielectric ceramic laminate in which only a plurality of layers of dielectric ceramic sheets are stacked or only a plurality of layers of magnetic ceramic sheets are stacked.

As understood from the description hitherto made, in accordance with this invention, since at least one pair of adjacent ceramic sheets are coupled with each other through a metallic oxide layer, preferably the metallic oxide layer formed using the sol-gel reaction of a metallic alkoxide solution which proceeds at a low temperature, the ceramic laminate is prevented from being deformed due to a difference in the thermal shrinkage coefficient between both ceramic sheets can be prevented, thereby providing a ceramic laminate with no warp and peeling.

1. A ceramic laminate comprising:
at least a pair of ceramic sheets which are adjacent to each other; and
an intermediate layer made of crystalline metallic oxide being located at a boundary between the ceramic sheets.

2. A ceramic laminate according to claim 1, wherein said intermediate layer is located in a concave area encircled by each of the wiring patterns which is formed on at least one surface of said ceramic sheet.

3. A ceramic laminate according to claim 1, wherein at least said pair of adjacent ceramic sheets have different thermal shrinkage coefficients.

4. A ceramic laminate according to claim 1, comprising:
one or more wiring patterns formed on at least one surface at least one of the ceramic sheets,
wherein the intermediate layer has a thickness equal to or less than a thickness of each of the wiring patterns.

5. A ceramic laminate according to claim 1, wherein the metallic oxide of said intermediate layer is SiO₂.

6. A ceramic laminate according to claim 5, wherein said intermediate layer has a density of 1.0-1.2 g/cm³.

7. A ceramic laminate according to claim 1, a gap between said adjacent ceramic sheets is filled with said intermediate layer.

8. A ceramic laminate according to claim 1, wherein said adjacent ceramic sheets have wiring patterns on their opposite surfaces, respectively, and at least one contact is formed by contact between both wiring patterns.

9. A method for manufacturing a ceramic laminate comprising the steps of:
superposing at least two ceramic sheets having different thermal shrinkage coefficients through a metallic alkoxide solution; and
heat-treating said ceramic sheets at a temperature in which said metallic alkoxide solution induces a sol-gel reaction so that said ceramic sheets are coupled with each other through an intermediate layer which is made of metallic oxide created by the sol-gel reaction.

10. A method for manufacturing a ceramic laminate according to claim 9, wherein said ceramic sheets which have been fired.

11. A method for manufacturing a ceramic laminate according to claim 9, wherein said heat-treating is performed under applying a pressure.

12. A method for manufacturing a ceramic laminate according to claim 9, wherein the metallic oxide of said intermediate layer is SiO₂.

13. A method for manufacturing a ceramic laminate according to claim 9, wherein said heat-treating is performed at a temperature of 400° C. or lower.

14. A ceramic laminate comprising:
at least a pair of ceramic sheets which are adjacent each other; and
an intermediate layer made of metallic oxide being located at a boundary between the ceramic sheets, the metallic oxide being formed by heat-treating a metallic alkoxide solution at a temperature inducing a sol-gel reaction.

15. A ceramic laminate comprising:
at least a pair of ceramic sheets which are adjacent each other; and
an intermediate layer made of metallic oxide being located at a boundary between the ceramic sheets, the intermediate layer is located only in a concave area by each of the wiring patterns which is formed on at least one surface of said ceramic sheet.
